(19) United States
(12) Patent Application Publication
(10) Pub. No.: US 2014/0130923 A1
(43) Pub. Date: May 15, 2014

(54) Flow Guider and Devices with the Same

(71) Applicant: Chen-Chuan Hu, New Taipei City (TW)

(72) Inventor: Chen-Chuan Hu, New Taipei City (TW)

(21) Appl. No.: 14/033,605

(22) Filed: Sep. 23, 2013

(30) Foreign Application Priority Data
Nov. 14, 2012 (TW) 101221982

(51) Int. Cl. F15D 1/10

(52) U.S. Cl. CPC F15D 1/10
USPC 137/899; 137/561 R; 137/357

(57) ABSTRACT

A flow guider has a guiding body, a blade edge and two tips. The guiding body has two guiding surfaces configured symmetrically with each other. Each guiding surface is convex. The blade edge is curved, is formed between and connects the guiding surfaces and has two opposite ends. The tips are formed respectively at the ends of the blade edge and each tip merges the guiding surfaces and one end of the blade edge. The flow guider divides and guides oncoming airflow or waterflow to smoothly pass across the flow guider with reduced turbulence so that vehicles or bridge piers mounted with the flow guiders suffer less vibration, shaking and damage when encountering airflow or waterflow.

### BACKGROUND OF THE INVENTION

1. Field of the Invention

The present invention relates to a flow guider that may be applied to vehicles such as cars, trains, trams and ships, or bridge piers to guide airflow or waterflow to smoothly cross over the vehicles so that turbulence around the vehicles or bridge piers is decreased.

2. Description of Related Art

Vehicles such as cars, trains, trams and ships are widely used mobile machines for accommodating and transporting passengers or cargo between distant places.

Rail vehicles such as trains on rails or bullet trains on high speed rails are designed to have larger passenger and cargo capacity and higher transportation speed when compared to cars, and are employed to relieve traffic congestion of the highway on which cars travel.

When two opposite rail vehicles pass each other at high speed, intermediate airflow between the passing rail vehicles generates turbulence to vibrate or shake the rail vehicles. Such vibration and shaking make passengers in the rail vehicles feel uncomfortable and disturbed.

When a rail vehicle or high speed road vehicle such as a racing car moves at high speed, oncoming airflow impacts the body of the vehicle and turbulence is caused to vibrate or shake the vehicle.

Furthermore, navigation vehicles such as boats, ships and liners under circumstances with headwind or ocean countercurrent also vibrate and shake under the impact of turbulence.

Piers of a bridge also suffer the impacts from waterflow that causes the bridge to vibrate and shake.

To overcome the shortcomings, the present invention provides a flow guider and devices with the same to mitigate or obviate the aforementioned problems.

### SUMMARY OF THE INVENTION

The main objective of the invention is to provide vehicles such as cars, trains, trams and ships, or bridge piers to guide airflow or waterflow to smoothly cross over the vehicles such that turbulence around the vehicles or bridge piers is decreased.

A flow guider in accordance with the present invention has a guiding body, a blade edge and two tips. The guiding body has two opposite guiding surfaces configured symmetrically with each other. Each guiding surface is convex. The blade edge is curved, is formed between and connects the guiding surfaces and has two opposite ends. The tips are formed respectively at the ends of the blade edge and each tip merges the guiding surfaces and one end of the blade edge. The flow guider divides and guides oncoming airflow or waterflow to smoothly pass across the flow guider with reduced turbulence so that vehicles or bridge piers mounted with the flow guiders suffers less vibration, shaking and damage when encountering airflow or waterflow.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a flow guider in accordance with the present invention;

FIG. 2 is an exploded perspective view of the flow guider in FIG. 1 and a sheet metal of a vehicle;

FIG. 3 is an operational exploded perspective view of the flow guider and the sheet metal in FIG. 2 mounted with each other with fasteners;

FIG. 4 is a perspective view of the flow guider mounted on the sheet metal in FIG. 3;

FIG. 5 is a cross sectional front view of a guiding body of the flow guider in FIG. 1;

FIG. 6 is a cross sectional side view of the guiding body of the flow guider in FIG. 1;

FIG. 7 is a perspective view of a land vehicle equipped with the flow guiders in FIG. 1;

FIG. 8 is an operational side view of the land vehicle equipped with the flow guiders in FIG. 7;

FIG. 9A is an operational side view of the land vehicle equipped with the flow guiders in FIG. 8;

FIG. 9B is an enlarged side view of the land vehicle in FIG. 9A;

FIG. 10 is an operational side view of the land vehicle equipped with the flow guiders in FIG. 9A;

FIG. 11 is a side view of a navigation vehicle equipped with the flow guiders in FIG. 1;

FIG. 12 is a side view of a bridge equipped with the flow guiders in FIG. 1;

FIG. 13 is a side view of another bridge equipped with the flow guiders in FIG. 1;

FIG. 14 is a perspective view of the land vehicle equipped with the flow guiders moving along a curved bridge equipped with the flow guiders;

FIG. 15 is a top view of two opposite land vehicles equipped with flow guiders passing each other;

FIG. 16 is a perspective view of a building equipped with the flow guiders; and

FIG. 17 is a perspective view of the buildings in FIG. 16 against natural disasters.

### DETAILED DESCRIPTION OF THE PREFERRED EMBODIMENT

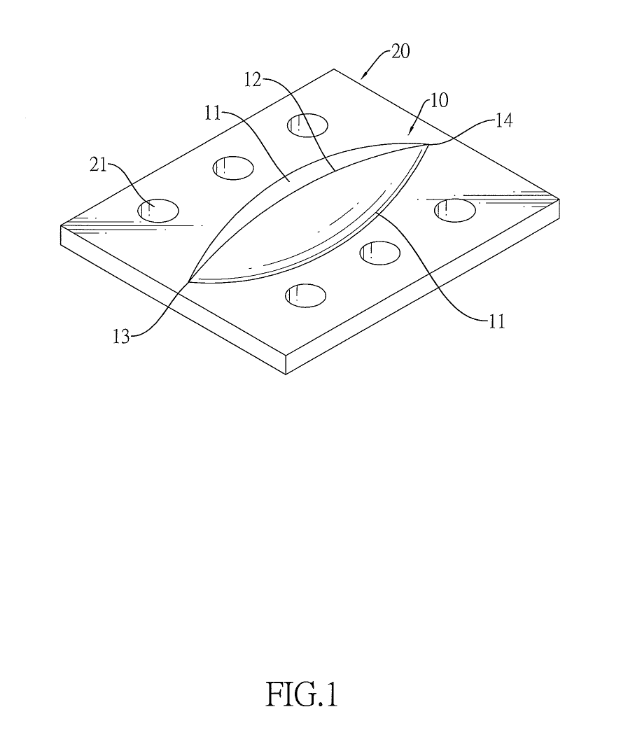

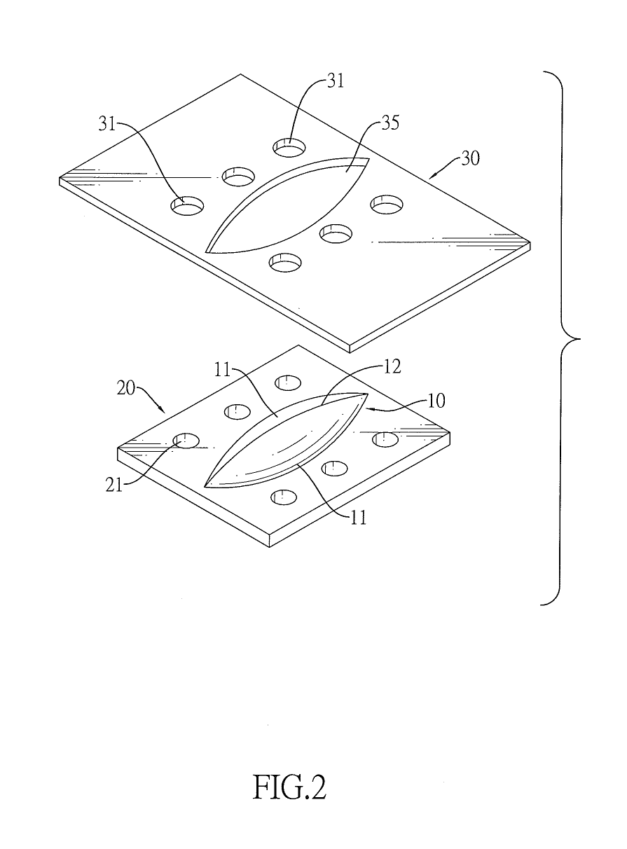

With reference to FIGS. 1 and 2, a first embodiment of a flow guider in accordance with the present invention may be mounted on a sheet metal 30 of a vehicle or a bridge pier. The sheet metal 30 has a mounting opening 35 and multiple fastening holes 31 formed through the sheet metal 30.

The flow guider comprises a guiding body 10 and may further comprise a mounting plate 20.

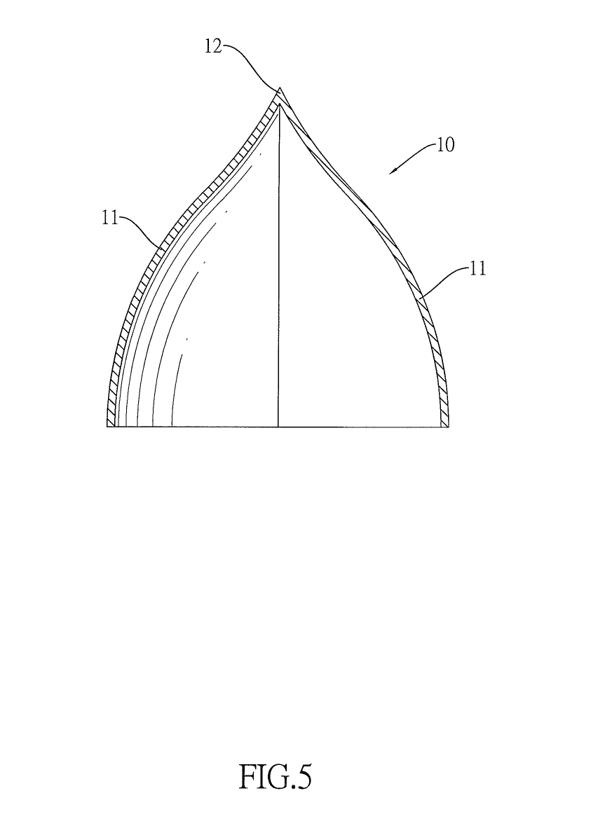

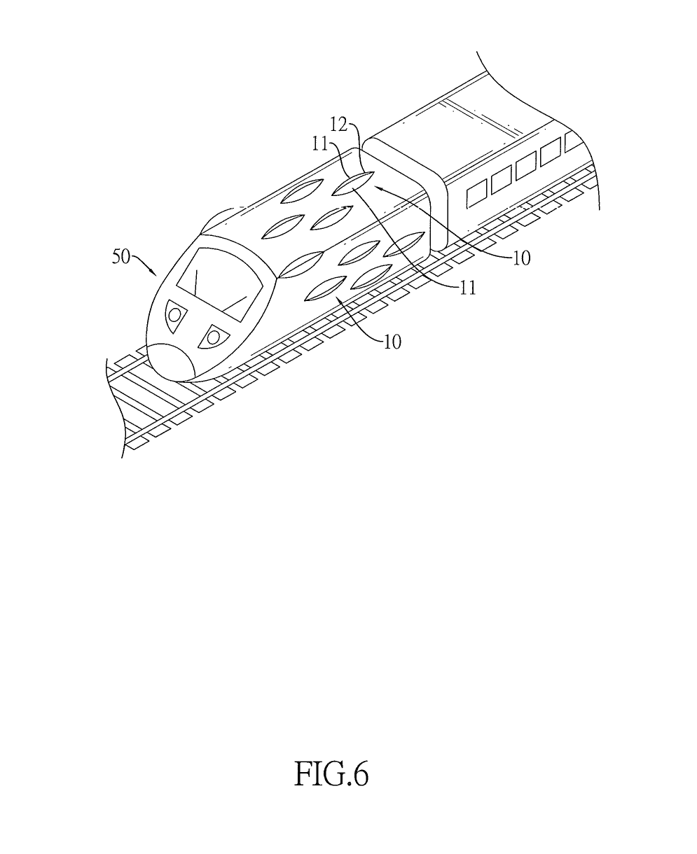

With further reference to FIGS. 5 and 6, the guiding body 10 is fin-shaped when observed from a left or right side view, is leaf-shaped when observed from a top view and has two opposite guiding surfaces 11, a blade edge 12 and two tips 13 and 14.

The guiding surfaces 11 are connected to each other by the blade edge and are configured symmetrically with each other. Each guiding surface 11 is convex so that a flow may smoothly move along the guiding surface 11.

The blade edge 12 is curved and formed between the guiding surfaces 11 and has two opposite ends. When the guiding body 10 is observed from the left or right side view, the blade edge 12 is hill-like with an intermediate raised section and two outer sloping sections extending from the intermediating raised section. When the flow guider encounters a flow, the blade edge 12 cuts and divides the flow into two sub-flows to prevent the flow from colliding and impacting the guiding body 10. Furthermore, the sub-flows smoothly move respectively along the guiding surfaces 11 without incurring excessive turbulence.

The tips 13 and 14 are formed respectively at the two opposite ends of the blade edge and correspond to the lower sections of the blade edge 12. Each tip 13 and 14 merges the guiding surfaces 11 and one end of the blade edge 12.

The mounting plate 20 is attached to the guiding body 10, may be mounted on the guiding body 10 or formed integrally on the guiding body 10 and has multiple assembling holes 21. The assembling holes 21 are formed through the mounting plate 20 and may be threaded.

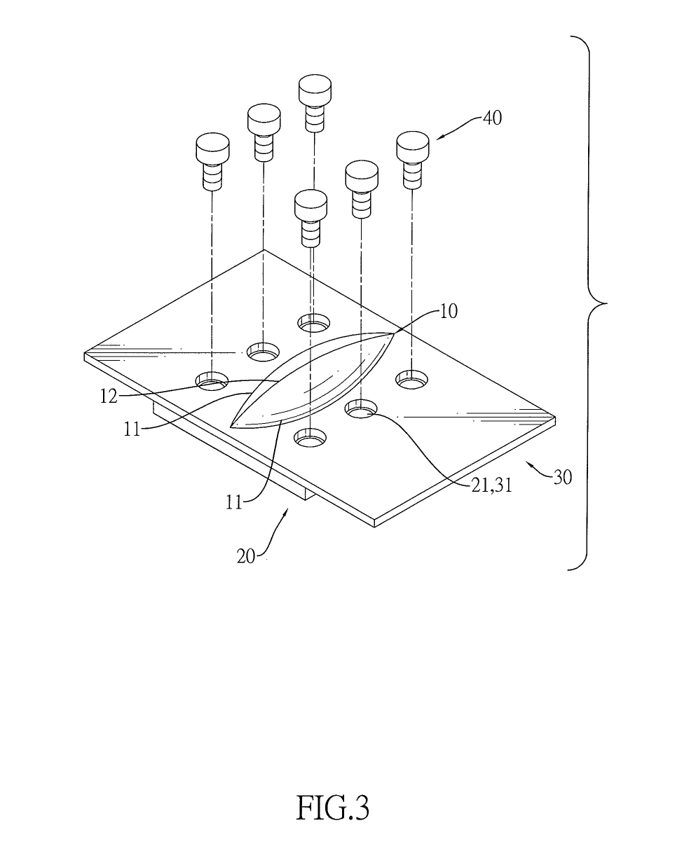

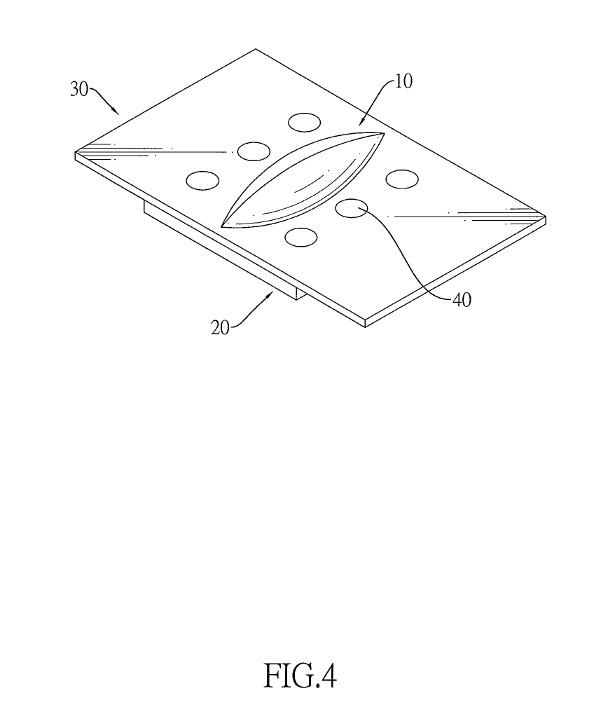

With further reference to FIGS. 3 to 4, when the flow guider is mounted on the sheet metal 30 of a vehicle, the guiding body 10 of the flow guider extends through the mounting opening 35 of the sheet metal 30. Multiple fasteners 40 such as bolts or rivets extend respectively through the fastening holes 31 of the sheet metal 30 and are mounted respectively and securely through the assembling holes 21 of the mounting plate 20 so that the flow guider is fastened under the sheet metal 30.

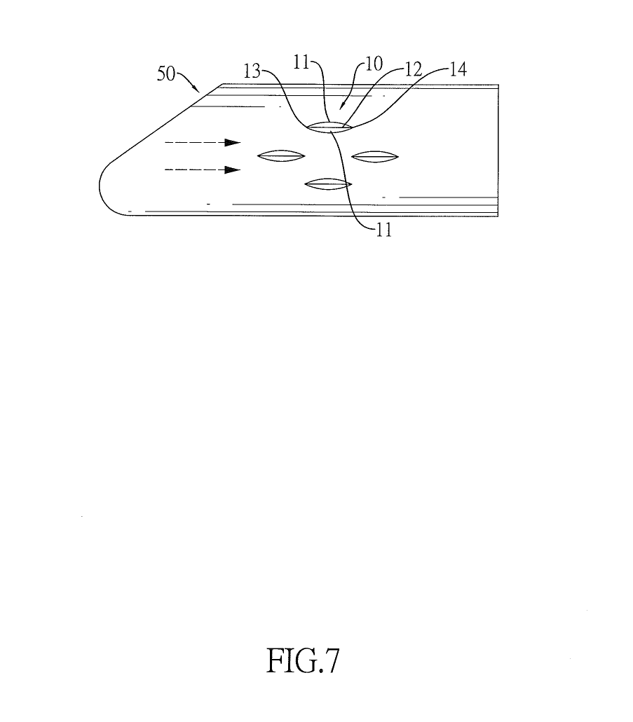

With further reference to FIG. 7, a land vehicle 50, which may be a train or a car, has a sheet metal and multiple flow guiders mounted on the sheet metal. The flow guiders may be located on a roof, a left side or a right side of the land vehicle 50.

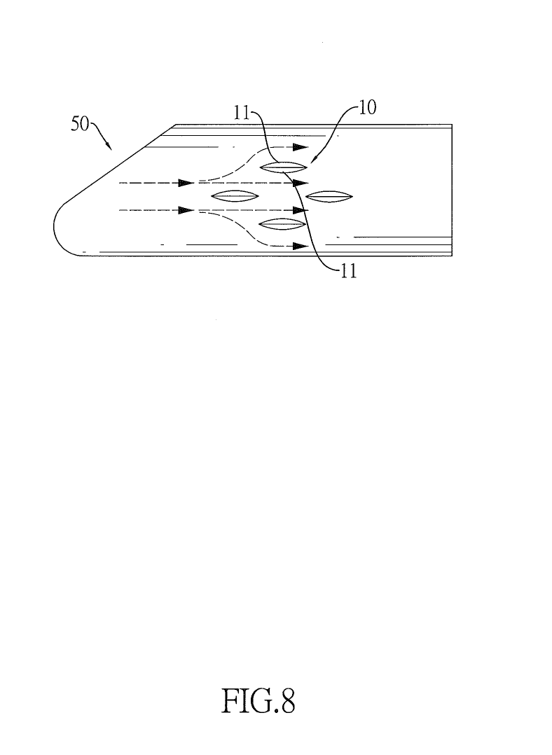

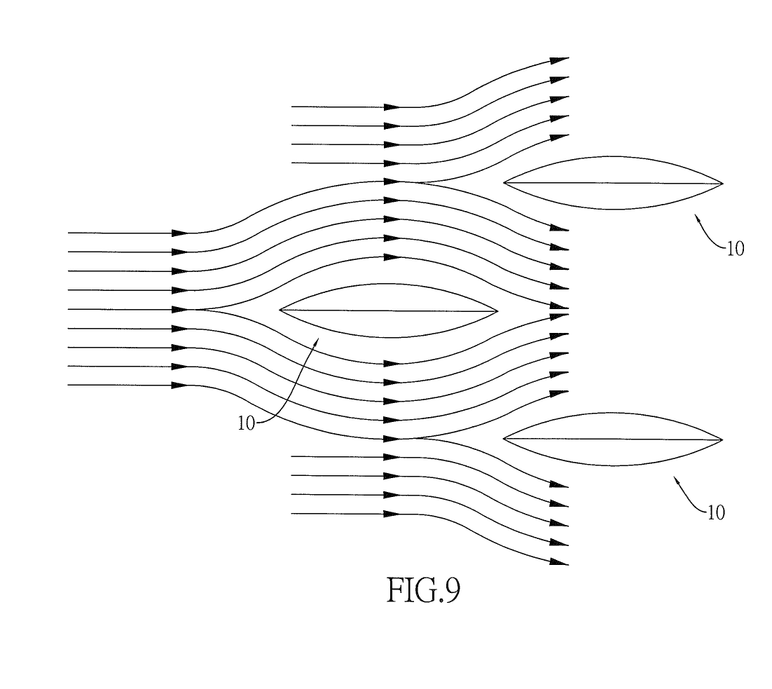

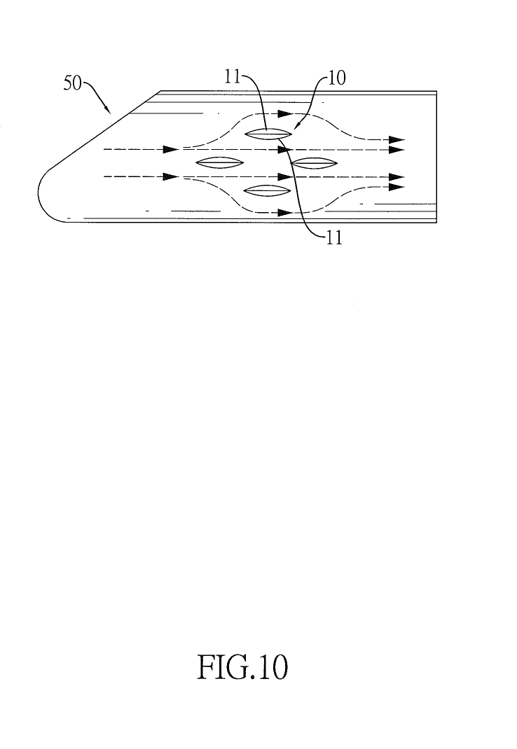

With further reference to FIGS. 8 to 10, when the land vehicle 50 is driven to move at high speed, the guiding bodies 10 of the flow guiders divide oncoming airflow into several sub-airflows and guide the sub-airflows to smoothly move and pass along the guiding surfaces 11. Therefore, turbulence caused by the airflow is decreased.

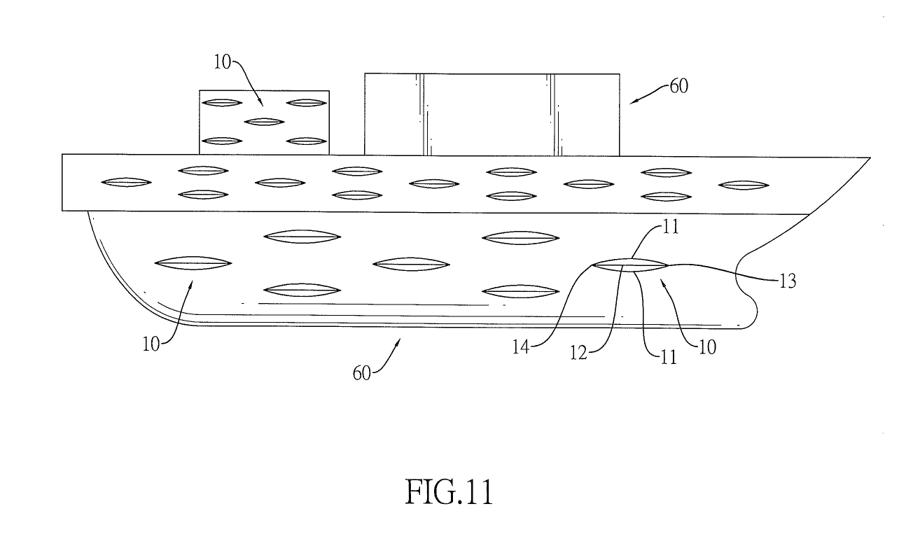

With further reference to FIG. 11, a navigation vehicle 60, which may be a ship, a boat or a liner, has a sheet metal and multiple flow guiders mounted on the sheet metal. The flow guiders may be located on an outer surface of the navigation vehicle 60. When the navigation vehicle 60 is driven to move at high speed, the guiding bodies 10 of the flow guiders divide oncoming airflow into several sub-airflows and guide the sub-airflows to smoothly move and pass along the guiding surfaces 11. Therefore, turbulence caused by the airflow is decreased.

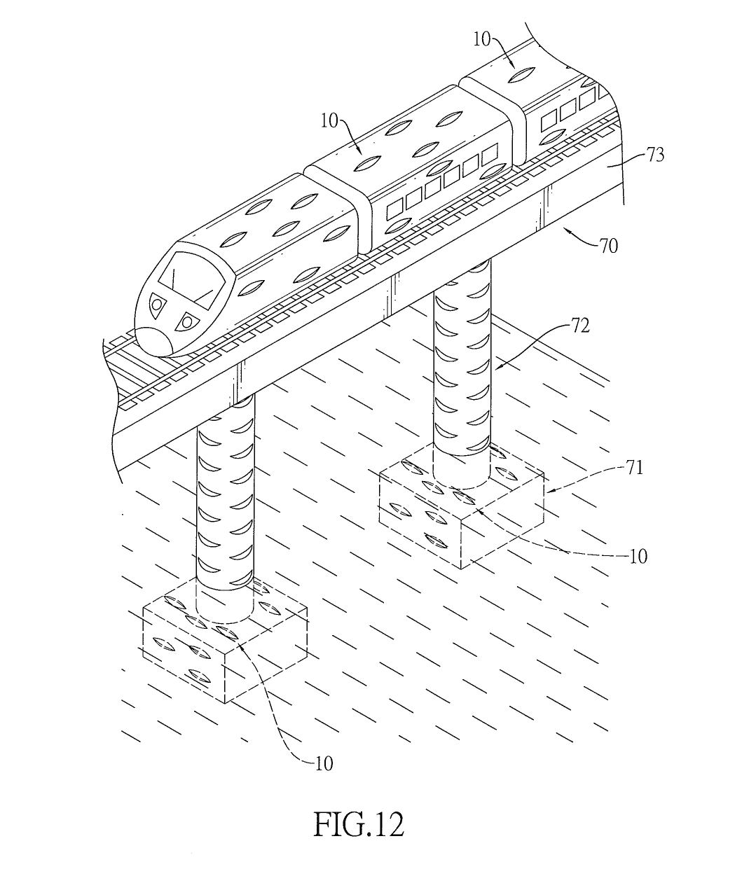

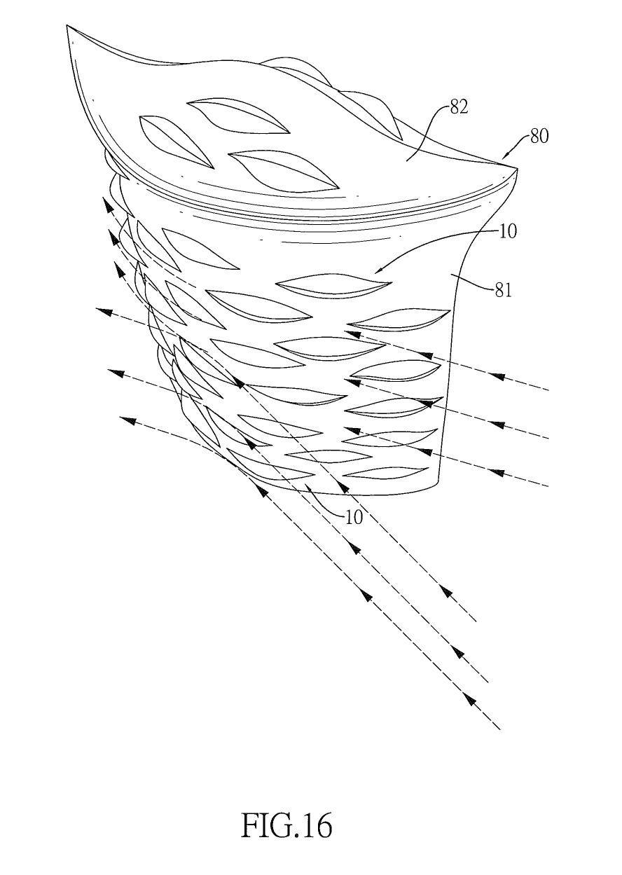

With further references to FIGS. 12 and 16, a bridge has a deck 73 and multiple piers.

The piers support the deck 73 and each pier has a foundation 71 and a column 72. The foundation 71 is submerged in water of river or sea and has multiple flow guiders mounted on an outer surface thereof. The column 72 is mounted on the foundation 71.

When waterflow impacts the foundations 71, the guide flowers on the surfaces of the foundations 71 split oncoming waterflow into multiple sub-waterflows and guide the sub-waterflows to smoothly move and pass along the guiding surfaces 11 of the guiding body 10 of each flow guider. Therefore, impact of waterflow on the piers is decreased to prevent the bridge from being damaged.

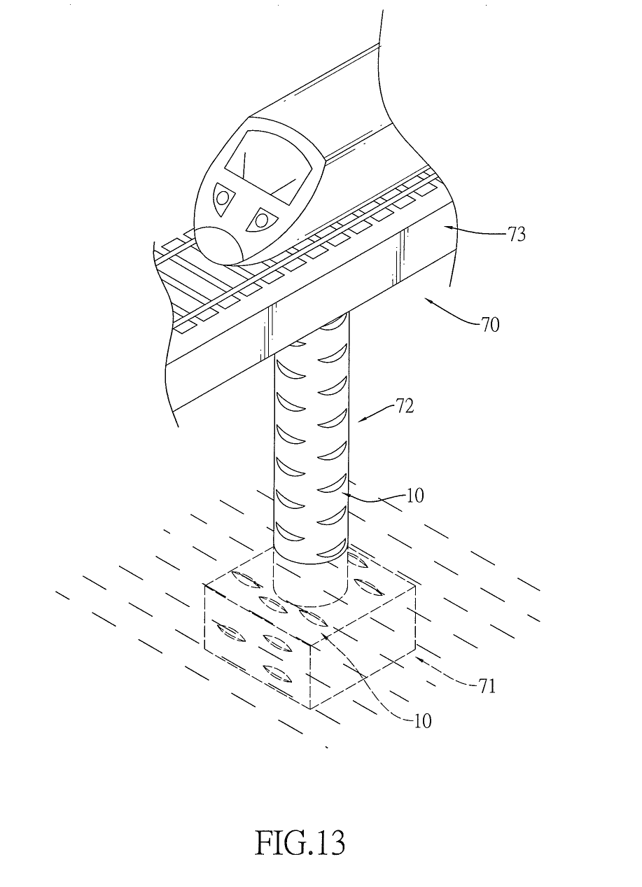

With further reference to FIG. 13, each pier of the bridge may further have multiple flow guiders mounted on the column 72 to guide waterflow or airflow to smoothly pass by.

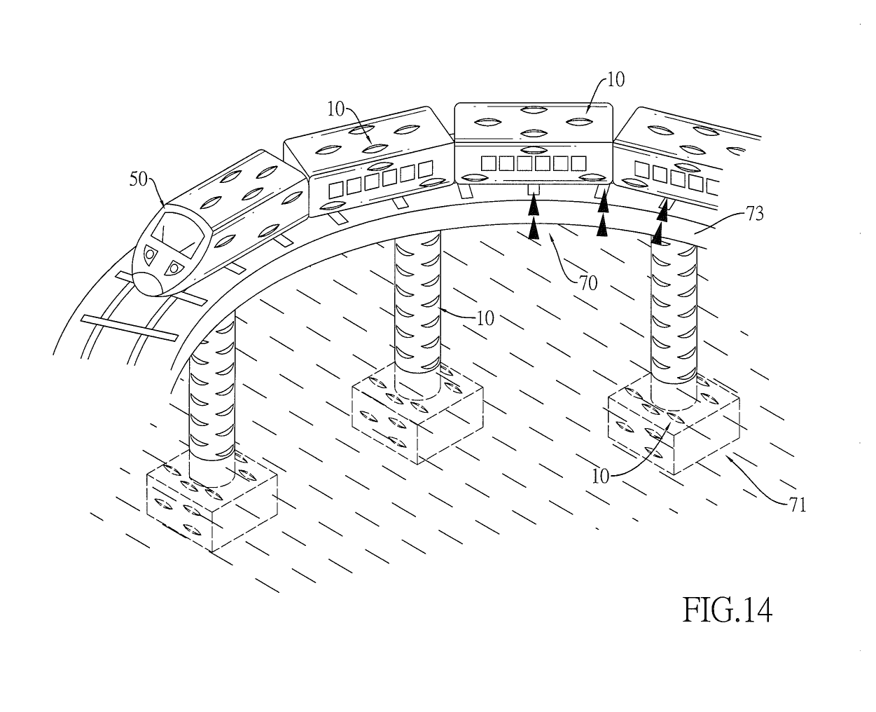

With further reference to FIG. 14, when a land vehicle 50 such a train is moving on a curved rail on the bridge, the wind impacting on the curved part of the land vehicle 50 would be divided and eased by flow guiders on the land vehicle 50. The flow guider divides and guides oncoming airflow or waterflow to smoothly pass across the flow guider with reduced turbulence so that vehicles or bridge piers mounted with the flow guiders suffer less vibration, shaking and damage when encountering airflow or waterflow.

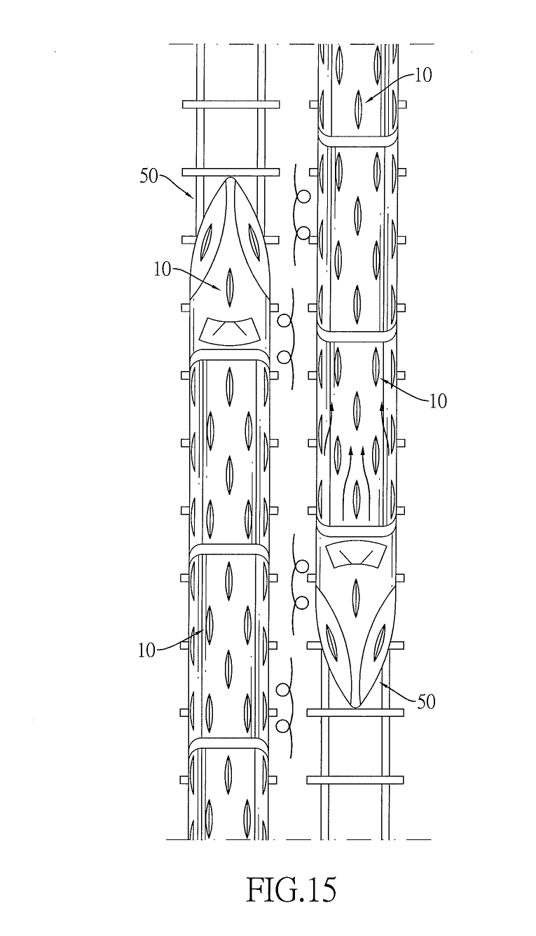

With further reference to FIG. 15, two opposite rail vehicles equipped with flow guiders are passing each other. The flow guiders allow the rail vehicles to pass each other smoothly without causing turbulence and vibration.

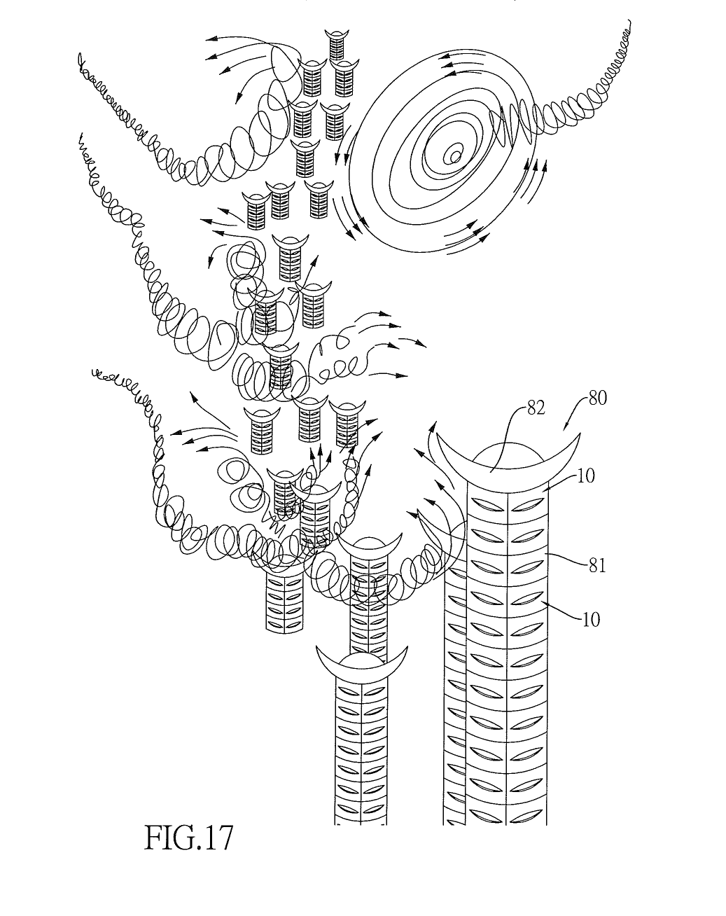

With further reference to FIGS. 16 and 17, a building 80 has multiple flow guiders mounted on a sidewall 81 and a roof 82. The building 80 equipped with flow guiders can reduce impacts and damages from natural disasters such as hurricanes or typhoons.

Even though numerous characteristics and advantages of the present invention have been set forth in the foregoing description, together with details of the structure and function of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A flow guider comprising:
a guiding body having
two opposite guiding surfaces configured symmetrically with each other, and each guiding surface being convex;
a blade edge being curved, formed between and connecting the guiding surfaces and having two opposite ends; and
two tips formed respectively at the ends of the blade edge and each tip merging the guiding surfaces and one end of the blade edge.

2. The flow guider as claimed in claim 1, wherein
the guiding body is fin-shaped when observed from a left or right side view and is leaf-shaped when observed from a top view; and
when the guiding body is observed from the left or right side view, the blade edge is hill-like with an intermediate raised section and two outer sloping sections extending from the intermediating raised section.

3. The flow guider as claimed in claim 2 further comprising a mounting plate attached to the guiding body and having multiple assembling holes defined through the mounting plate.

4. A land vehicle comprising:
a sheet metal; and
multiple flow guiders mounted on the sheet metal and each flow guider having a guiding body having
two opposite guiding surfaces configured symmetrically with each other, and each guiding surface being convex;
a blade edge being curved, formed between and connecting the guiding surfaces and having two opposite ends; and
two tips formed respectively at the ends of the blade edge and each tip merging the guiding surfaces and one end of the blade edge.

5. The land vehicle as claimed in claim 4, wherein
each guiding body is fin-shaped when observed from a left or right side view and is leaf-shaped when observed from a top view; and
when the guiding body is observed from the left or right side view, the blade edge is hill-like with an intermediate raised section and two outer sloping sections extending from the intermediating raised section.

6. The land vehicle as claimed in claim 5 further comprising a mounting plate attached to the guide body and having multiple assembling holes defined through the mounting plate.

7. A navigation vehicle comprising:
a sheet metal; and
multiple flow guiders mounted on the sheet metal and each flow guider has a guiding body having
two opposite guiding surfaces configured symmetrically with each other, and each guiding surface being convex;
a blade edge being curved, formed between and connecting the guiding surfaces and having two opposite ends; and
two tips formed respectively at the ends of the blade edge and each tip merging the guiding surfaces and one end of the blade edge.

8. The navigation vehicle as claimed in claim 7, wherein
each guiding body is fin-shaped when observed from a left or right side view and is leaf-shaped when observed from a top view; and
when the guiding body is observed from the left or right side view, the blade edge is hill-like with an intermediate raised section and two outer sloping sections extending from the intermediating raised section.

9. The navigation vehicle as claimed in claim 8 further comprising a mounting plate attached to the guiding body and having multiple assembling holes defined through the mounting plate.

10. A bridge pier comprising
a foundation having multiple flow guiders mounted on an outer surface thereof; and
a column mounted on the foundation;
wherein each flow guider has a guiding body having
two opposite guiding surfaces configured symmetrically with each other, and each guiding surface being convex;
a blade edge being curved, formed between the guiding surfaces and having two opposite ends; and
two tips formed respectively at the ends of the blade edge and each tip merging the guiding surfaces and one end of the blade edge.

11. The bridge pier as claimed in claim 13, wherein the column further has multiple flow guiders mounted on the column and each flow guider is identical with the flow guiders on the foundation.

12. A building comprising:
a sidewall;
a roof; and
multiple flow guiders mounted at least on the sidewall and each flow guider having a guiding body having
two opposite guiding surfaces configured symmetrically with each other, and each guiding surface being convex;
a blade edge being curved, formed between and connecting the guiding surfaces and having two opposite ends; and
two tips formed respectively at the ends of the blade edge and each tip merging the guiding surfaces and one end of the blade edge.

13. The building as claimed in claim 12, wherein the flow guiders are mounted on both the sidewall and roof.
